(19) United States
(12) Patent Application Publication
(10) Pub. No.: US 2025/0323516 A1
(43) Pub. Date: Oct. 16, 2025

(54) METHOD FOR OPERATING AN ELECTRICAL POWER SUPPLY DEVICE, SWITCH-OFF CONTROL DEVICE, AND POWER SUPPLY DEVICE

(71) Applicant: ads-tec Energy GmbH, Nürtingen (DE)

(72) Inventors: Holger DREHER, Holzgerlingen (DE); Holger OCHS, Mötzingen (DE)

(21) Appl. No.: 19/176,286

(22) Filed: Apr. 11, 2025

(30) Foreign Application Priority Data
Apr. 11, 2024 (DE) 102024110210.1

(51) Int. Cl. H02J 7/00; B60L 53/62

(52) U.S. Cl. CPC H02J 7/0031; B60L 53/62

(57) ABSTRACT

The invention relates to a method for operating an electrical power supply device for unidirectional or bidirectional charging of an energy storage device, wherein
a temporal charging parameter gradient of a charging parameter which is characteristic of the charging process is acquired during a charging process, wherein
if a fault of the charging process is inferred on the basis of the charging parameter gradient, the emergency measure is carried out to protect the power supply device and/or the energy storage device from damage.

The invention also relates to a switch-off control device for carrying out such a method and a power supply device with such a switch-off control device.

The invention relates to a method for operating an electrical power supply device for unidirectional or bidirectional charging, in particular of an energy storage device, a switch-off control device and a power supply device.

When charging an energy storage device, in particular an electric vehicle, by means of a power supply device, it is necessary to ensure that a maximum charging amperage and/or a maximum charging voltage is not exceeded to prevent damage to the energy storage device and/or the power supply device. In particular, it must be ensured that an electrical connection, in particular a power circuit, is interrupted in the event of a malfunction of the power supply device and/or the electrical energy storage device.

It is known that electric vehicles have a fuse that interrupts the power circuit in the event of a malfunction of the power supply device. If, for example, a short circuit occurs in the power supply device during a bidirectional charging process—when the electric vehicle is transmitting electrical energy to the power supply device—the electric vehicle transmits energy to the power supply device at such a high power that the fuse of the electric vehicle blows. The disadvantage of these fuses is that, when opened under a high current load, they have to be replaced after just a few switching operations. Such fuses can also be integrated into a battery of the electric vehicle. The electric vehicle is no longer functional after the fuse has tripped. To restore the functionality of the electric vehicle functionality, the electric vehicle must be towed and the fuse replaced and/or activated manually. Alternatively, the entire battery must be replaced after the fuse has blown.

It is also known that the power supply devices can have fuses. The fuses are configured to interrupt the power circuit in the event of a malfunction of the power supply device. The disadvantage of this is that the reaction time of these fuses is so long that both the fuse of the power supply device and the fuse of the electric vehicle are blown. Furthermore, it is not possible to interrupt the power circuit in the event of a malfunction of the power supply device before the electric vehicle fuse is tripped and thus maintain the functionality of the electric vehicle. Another problem is that a wide variety of electric vehicles can be charged at such a power supply device, so that the power supply device does not know the tripping characteristics of the fuse of the electric vehicle and the fuse thus cannot be protected.

The object of the invention is thus to provide a method for operating an electrical power supply device, a switch-off control device and a power supply device, wherein the aforementioned disadvantages are at least reduced, preferably avoided.

The object is solved by providing the present technical teaching, in particular the teaching of the independent claims and the embodiments disclosed in the dependent claims and the description.

The object is solved in particular by creating a method for operating an electrical power supply device, in particular a charging station, for unidirectional or bidirectional charging of an energy storage device, in particular of an electric vehicle, in particular a battery storage of an electric vehicle. In the method, a temporal charging parameter gradient of a charging parameter which is characteristic of the charging process is acquired during a charging process. If a fault of the charging process is inferred on the basis of the charging parameter gradient, an emergency measure is carried out to protect the power supply device and/or the energy storage device from damage.

Advantageously, a fault of the charging process can be inferred earlier in time by means of the charging parameter gradient than by means of the assigned charging parameter itself. In particular, the reaction time of the method is in the range of microseconds. In particular, it is not necessary for a charging parameter itself to reach a charging parameter threshold value before a fault of the charging process can be inferred. It is already sufficient if a charging parameter change rate—the charging parameter gradient—is outside a predetermined range or above a threshold value to detect a fault of the charging process. It is thus advantageously not necessary to know a tripping characteristic and/or a rated current of a fuse of the electric vehicle. In particular, no fixed switch-off thresholds of the power supply device are necessary. By means of the method, energy storage devices which have fuses with different tripping characteristics and/or rated currents can thus also be protected against damage without these tripping characteristics and/or rated currents of the power supply device being known. Advantageously, this makes it possible to interrupt the power circuit of the electrical power supply device in the event of a malfunction of the same before an energy storage device registers the malfunction and, in particular, before a fuse of the energy storage device is tripped.

In the context of the present technical teaching, the term “charging” is understood to mean not only charging but also, in particular, discharging. In particular, the energy storage device is charged by the power supply device during a charging process. In particular, the energy storage device is discharged during a discharge process, wherein the energy is transferred to the power supply device. The transmitted energy can be passed on to a power grid to which the power supply device is connected to stabilize or temporarily support such power grid. The power supply device thus serves as an access point to the power grid. Alternatively or in addition, a device energy storage of the power supply device can be charged with the transmitted energy. Unidirectional charging typically comprises only charging processes, while bidirectional charging comprises both charging and discharging processes. In the context of the present technical teaching, a charging parameter is thus understood in particular to be a charging parameter and a discharging parameter.

In the context of the present technical teaching, a positive charging current is an energy transfer from the power supply device to the energy storage device—i.e. a charging. Furthermore, in the context of the present technical teaching, a negative charging current is an energy transfer from the energy storage device to the power supply device—i.e. a discharging.

In one embodiment, the method monitors a bidirectional charging current. Advantageously, this also makes it possible to monitor a charging current from the energy storage device to the electrical power supply device. Advantageously, even in the event of a malfunction of the power supply device during bidirectional charging, it can be avoided that a fuse of the energy storage device is tripped and, for example, an electric vehicle is no longer functional. Rather, it is avoided that the fuse of the electric vehicle is even exposed to operation with charging parameters that deviate from normal operation. This is particularly advantageous for batteries that have an integrated fuse. Because the fuse is not tripped, these batteries no longer need to be replaced at great expense. Advantageously, towing and repairing the electric vehicle can be avoided altogether.

In electrical engineering, a power supply device, in particular a charging station, is any device or electrical system, in particular stationary or mobile, which is used to supply energy to mobile battery-powered devices, machines or motor vehicles by simply positioning them or plugging them in without necessarily having to remove the energy storage—such as the traction battery of an electric car. Charging stations for electric cars are sometimes also referred to as “electric charging stations” and can include a plurality of charging points. High performance charging systems or high power charging system (HPC systems) such as the combined charging system (CCS), which is widespread in Europe, are particularly well known. With generic direct current charging, direct current from the charging station is fed directly into the vehicle's battery and provided by a powerful rectifier, preferably of the charging station, from the power grid or by large buffer accumulators at solar charging stations, for example. There is a battery management system in the vehicle that communicates directly or indirectly with the charging station to adjust the current and voltage or to terminate the process when a predetermined capacity limit is reached. Power electronics of the power circuit are usually located in the charging station. Since the direct current connections of the charging station are connected directly to the corresponding connections of the traction battery—without a detour through an AC/DC converter of the vehicle—high charging currents can be transmitted with low losses, which enables short charging times.

In one embodiment, the power supply device, in particular the charging station, is formed as a charging pole. In particular, the charging station has at least one charging point, in particular exactly one charging point or exactly two charging points.

In particular, the charging station is designed as a fast charging station. In one embodiment, the charging station is designed as a battery-supported charging station, in particular as a battery-supported fast charging station, and thus has a device energy storage.

According to a further development of the invention, it is provided that the charge parameter gradient is acquired directly, wherein the charge parameter gradient is compared with a predetermined gradient threshold value. A fault of the charging process is inferred if the charging parameter gradient acquired exceeds the predetermined gradient threshold value. Alternatively, it is provided that the charging parameter gradient is indirectly acquired by measuring a measurement parameter which is characteristic of the charging parameter gradient, wherein the measurement parameter is compared with a predetermined measurement parameter threshold value, wherein a fault of the charging process is inferred if the measurement parameter exceeds the predetermined measurement parameter threshold value.

In one embodiment, the charge parameter gradient and/or the measuring parameter is acquired unsigned, in particular as an amount, squared amount or square root of the squared amount. Accordingly, the gradient threshold value and/or the measuring parameter threshold value is preferably an unsigned variable, in particular an amount. Thus, the charging parameter gradient or the characteristic measuring parameter exceeding the assigned threshold value means in particular that its amount becomes greater—and thus in particular “steeper”—than the threshold value, regardless of the sign of the charging parameter gradient or the characteristic measuring parameter.

In the context of the present technical teaching, the charging parameter gradient being directly acquired means in particular that a physical variable of the charging parameter gradient is acquired directly and derived temporally. In particular, a charging power, charging amperage or charging voltage is acquired directly.

In the context of the present technical teaching, the charging parameter gradient being indirectly acquired means in particular that a physical variable dependent on the charging parameter gradient is directly acquired, namely the measuring parameter which is characteristic of the charging parameter gradient. In particular, a time gradient of the charging power, a charging amperage or a charging voltage is acquired indirectly—by measuring the measuring parameter which is characteristic of the charging parameter gradient.

According to a further development of the invention, it is provided that, as an emergency measure, a power circuit of power electronics, in particular of the power supply device or the energy storage device, is interrupted, in particular in such a way that the charging process is interrupted.

In one embodiment, the power circuit is interrupted by means of a switch-off arrangement. In particular, the switch-off arrangement is configured to interrupt the power circuit.

According to a further development of the invention, it is provided that at least one charging current variable is used as the charging parameter, which charging current variable is selected from a group consisting of: A charging power, a charging amperage, a charging voltage and a combination of at least two of the above charging current variables.

In one embodiment—if the charging parameter gradient is acquired indirectly—it is provided that the measuring parameter is a voltage that drops due to an inductance, in particular of electronic components of the power supply device, in particular of a switch-off control device of the power supply device, across a measuring segment through which the charging current or a partial current dependent on the charging current flows. The voltage u(t) dropping across the measuring segment having the inductance L is directly dependent on—in particular according to the equation u(t)=L·dI(t)/dt proportional to—the time gradient of the charging current or partial current I(t) and thus dependent on the charging parameter gradient. In one embodiment, the measuring parameter acquired is a voltage drop across a coil through which the charging current or partial current flows. Alternatively, the measuring segment has the inductance as a parasitic inductance. In this context, ‘parasitic’ means in particular that a line section or multiple undefined, not clearly delimited components and/or line sections of the power supply device and/or the energy storage device, are the cause of the inductance.

According to a further development of the invention, it is provided that at least one threshold value, selected from the gradient threshold value and the measurement parameter threshold value, is set in dependence on a limit charging parameter which is selected from a group consisting of: A permissible power gradient upper limit, a permissible power upper limit, a permissible amperage gradient upper limit, a permissible amperage upper limit, a permissible voltage gradient upper limit, a permissible voltage upper limit and a combination of at least two of the aforementioned limit values.

In one embodiment, the limit charging parameter is acquired by receiving data of a data transmission between the power supply device and the energy storage device during a charging process. The data contains at least the one limit charging parameter which is characteristic of the charging process. In dependence on the at least one limit charging parameter, the gradient threshold value of the power supply device is set for the charging parameter gradient. If the charge parameter gradient exceeds the gradient threshold value, an emergency measure is carried out, in particular to protect the power supply device and/or the energy storage device from damage.

In one embodiment, it is provided that the gradient threshold value is set by determining a nominal charging parameter threshold value of the power supply device for the charging parameter in dependence on the at least one limit charging parameter. It is checked whether a current actual value of the gradient threshold value of the power supply device is equal to a nominal value of the gradient threshold value, in particular whether it has the same value. If the current actual value is not equal to the nominal value, in particular does not have the same value, the gradient threshold value is adjusted so that a new actual value of the gradient threshold value is equal to the nominal value, in particular has the same value.

In one embodiment, the data of a data transmission that uses an electrical line in the low-voltage network (Powerline Communication (PLC) and/or a serial bus system (Controller Area Network (CAN) is acquired and/or received. In particular, the acquisition device is configured to receive data of a data transmission that uses an electrical line in the low-voltage network (Powerline Communication (PLC) and/or data of a data transmission that uses a serial bus system (Controller Area Network (CAN). In particular, the electrical line runs from the power supply device to the energy storage device, in particular within a charging cable. In particular, the electrical line is a line different from the power circuit within the charging cable.

The data can be acquired directly or indirectly: The data can be acquired directly by configuring an acquisition device to communicate with the power supply device via a communication interface, preferably a serial bus system or a network interface. Preferably, the acquisition device communicates directly with the control device and/or the power electronics. The data can be acquired indirectly, in that the acquisition device is configured to acquire the data transmission on a data transmission path, in particular without communicating directly with the control device for this purpose. In particular, the data transmission path can be opened, in particular separated, wherein the acquisition device is placed in between and the data transmission path is closed again.

Alternatively, it is possible for the acquisition device to detect the data transmission without an electric connection to the data transmission path itself—in other words, to listen to the data transmission, in particular electrically contactless, in particular galvanically decoupled, in particular inductively. This is preferably done on the line or charging cable.

Advantageously, the at least one gradient threshold value can be flexibly adjusted to different energy storage devices. For example, the gradient threshold value can be set lower—thus less “steep”—for a small electric vehicle with a maximum charging amperage of 125 A—at a charging voltage of 400 V this results in a charging power of 50 kW—than for a commercial electric vehicle with a maximum charging amperage of 625 A—at a charging voltage of 400 V this results in a charging power of 250 kW—for which the gradient threshold value is set higher—thus “steeper”. Thus, various electric vehicles can be protected from damage.

In a preferred embodiment, the gradient threshold value is set in dependence on a permissible amperage gradient upper limit. In a preferred embodiment, the measuring parameter threshold is set in dependence on a permissible voltage upper limit.

In one embodiment, at least one threshold value, selected from the gradient threshold value and the measuring parameter threshold value, is set in dependence on a temporal fluctuation of the charging parameter and/or the charging parameter gradient and/or the measuring parameter.

In one embodiment, the amperage gradient is from 20 A/s to 100 A/s for a power supply device operated with a fault-free charging process. In contrast, the amperage gradient can be greater than 1.5 A/μs for a power supply device operated with a short-circuited energy storage device. In previous measurements, an amperage gradient of up to 340 A/μs was measured in the event of a short circuit. A ripple current of the charging current can have a ripple current gradient of up to 20 A/μs. After smoothing by means of a capacitance, in particular by means of a capacitor, the ripple current gradient of the ripple current can be up to 1 A/μs. The maximum permissible ripple current gradient according to the IEC61851-23 standard in its version valid on the date determining the priority of the present application can be 2.7 A/μs, in particular standardized to a charging amperage of 9 A with a ripple current frequency of up to 150 kHz. In particular, the ripple current is an alternating current of any frequency and waveform which is superimposed on a direct current, in particular the charging current. In particular, the charging current is superimposed with a ripple current which has a frequency of 80 kHz to 120 kHz, in particular 100 kHz.

In a preferred embodiment, the gradient threshold value is set depending on a permissible amperage gradient upper limit of a charging current of the charging process, wherein the amperage gradient upper limit is up to 100 A/s, in particular 100 A/s. In particular, the ripple current is smoothed in this embodiment, so that the ripple current gradient is up to 1 A/μs. Advantageously, this allows to quickly infer a fault of the charging process and to carry out the emergency measure, in particular to interrupt the power circuit.

In yet another preferred embodiment, the gradient threshold value is set as a function of an allowable amperage gradient upper limit of the ripple current and an allowable amperage gradient upper limit of the charging current. In particular, the gradient threshold value is set such that it lies in an interval between the permissible amperage gradient upper limit of the ripple current and the amperage gradient upper limit of the charging current. In one embodiment, the gradient threshold value is set to a value between 1 A/μs and 1.5 A/μs, in particular 1.3 A/μs.

According to a further development of the invention, it is provided that the charging parameter gradient and/or the measuring parameter is acquired on a line, a charging cable connecting the power supply device to the energy storage device, power electronics, an electrical interface and/or on a control device of the power supply device.

Advantageously, the charge parameter gradient and/or the measuring parameter can be easily acquired. It is possible for the charging parameter gradient and/or the measuring parameter to be acquired redundantly at different points, in particular at at least two points, of the power supply device. In particular, one point has at least two measuring points. The measuring points can, in particular, define the measuring segment, wherein the voltage between the measuring points is measured as the measuring parameter.

In one embodiment, the method is carried out repeatedly, in particular after a predetermined time interval, in particular cyclically. In particular, the method is carried out at a frequency of 10 kHz to 50 kHz.

The object is also solved by creating a switch-off control device for a power supply device for unidirectional or bidirectional charging of an energy storage device, in particular of an electric vehicle, in particular of a battery storage device of an electric vehicle. The switch-off control device is configured to carry out a method according to the invention or a method according to one or multiple of the previously described embodiments. In connection with the switch-off control device, the advantages already explained in connection with the method apply in particular.

According to a further development of the invention, it is provided that the switch-off control device is configured to be operatively connected to a power circuit of the power supply device and to interrupt the power circuit.

In one embodiment, the switch-off control device is configured to be controllably operatively connected to a switch-off arrangement of the power supply device.

According to a further development of the invention, it is provided that the switch-off control device is formed by a control device of the power supply device.

In particular, the control device is configured to be controllably operatively connected to the switch-off arrangement.

In one embodiment, the switch-off control device is integrated into a control device of the power supply device. In another embodiment, the switch-off control device is formed as a control device of the power supply device.

The object is also solved by creating a power supply device for unidirectional or bidirectional charging of an energy storage device, in particular of an electric vehicle, in particular of a battery storage of an electric vehicle. The power supply device comprises power electronics, a switch-off control device according to the invention or a switch-off control device according to one or multiple of the previously described embodiments, and an electrical interface. The power electronics are configured to selectively close or open a power circuit for charging the energy storage device. The electrical interface is configured to be connected to the energy storage device for charging the energy storage device.

In one embodiment, the power supply device has a switch-off arrangement. In particular, the switch-off control device is controllably operatively connected to the switch-off arrangement. In particular, the switch-off arrangement is configured to receive an interruption signal from the switch-off control device and then interrupt the power circuit.

In the context of the present technical teaching, an interruption signal is understood in particular to mean an electrical signal. The electrical signal can be a control voltage at a gate terminal of a power semiconductor component.

According to a further development of the invention, it is provided that the switch-off control device is integrated into a control device of the power supply device or is formed as a control device of the power supply device.

In particular, the control device is controllably operatively connected to the switch-off arrangement. In particular, the switch-off arrangement is configured to receive the interruption signal from the control device and then interrupt the power circuit.

In one embodiment, the switch-off arrangement has a first controllable power semiconductor component and a second controllable power semiconductor component. The first power semiconductor component and the second power semiconductor component are arranged antiserially. The first power semiconductor component and the second power semiconductor component are configured to conduct the charging current of the power supply device in a switched-on state. The switch-off control device is operatively connected to the first power semiconductor component and the second power semiconductor component and is configured for their respective control. Furthermore, the switch-off control device is configured to acquire the value of the at least one charging parameter which is characteristic of the charging current and, in dependence on the acquired value, to switch off the first power semiconductor component and/or the second power semiconductor component and thereby interrupt the charging current, in particular the power circuit.

Optionally, the switch-off arrangement has a diode, wherein the diode, the first power semiconductor component and the second power semiconductor component are arranged as a T-circuit.

In the context of the present technical teaching, in particular three electrical components are electrically connected to each other at a single connection point in a T-circuit. A first terminal of the first component, in particular the first power semiconductor component, and a first terminal of the second component, in particular the second power semiconductor component, are electrically connected to each other via the connection point. In addition, the first terminal of the first component and a first terminal of the third component, in particular the diode, are electrically connected to each other via the connection point. In addition, the first terminal of the second component and the first terminal of the third component, in particular the diode, are electrically connected to each other via the connection point. Furthermore, a second terminal of the first component and a second terminal of the third component are connected or connectable to a voltage or current source, in particular the power supply device or the energy storage device. In addition, a second terminal of the second component and the second terminal of the third component are connected or connectable to a load, in particular the energy storage device, wherein the voltage or current source and the load are formed differently.

In particular, the diode takes on the charging current after the interruption, which charging current is then slowly dissipated via the diode. Advantageously, it is possible to dissipate energy from a line inductance of the charging current by means of the diode. The charging current has a high amperage and a low voltage of less than 2 V when conducted via the diode. Furthermore, a switch-off time is also reduced.

In one embodiment, the switch-off arrangement is configured in such a way that a positive charging current is always conducted by the second power semiconductor component. In addition, the switch-off arrangement is configured such that a positive charging current from the first power semiconductor component is interrupted in dependence on the acquired value of the at least one characteristic charging parameter. Furthermore, the switch-off arrangement is configured in such a way that a negative charging current is always conducted by the first power semiconductor component. In addition, the switch-off arrangement is configured such that a negative charging current from the second power semiconductor component is interrupted in dependence on the acquired value of the at least one characteristic charging parameter. In the present case, this is also referred to as an antiparallel arrangement, in particular as “antiparallel”.

In the context of the present technical teaching, a power semiconductor component has at least one positive pole and at least one negative pole. Preferably, a power semiconductor component also has a control terminal, wherein the switch-off control device is electrically connected to the control terminal.

It is particularly preferred that the first power semiconductor component and/or the second power semiconductor component is formed to be unidirectionally blocking.

In one embodiment, it is provided that the switch-off control device is configured to compare the acquired value with a threshold value selected from the gradient threshold value and the measuring parameter threshold value, and, in dependence on the comparison, to switch off the first power semiconductor component and/or the second power semiconductor component and thereby interrupt the charging current. Advantageously, it is thus possible to decide in a simple and quick manner whether to switch off the first power semiconductor component and/or the second power semiconductor component.

In one embodiment, the switch-off control device is configured to determine a difference between the acquired value and the threshold value, and, in dependence on the difference, to switch off the first power semiconductor component and/or the second power semiconductor component, and thereby interrupt the charging current.

In one embodiment, it is provided that the first power semiconductor component has a first semiconductor switch and a first component diode, wherein the first semiconductor switch and the first component diode are arranged antiparallel. In addition, the second power semiconductor component has a second semiconductor switch and a second component diode, wherein the second semiconductor switch and the second component diode are arranged antiparallel. This ensures that an electric current flowing from the positive pole of the power semiconductor component to the negative pole of the power semiconductor component is conducted through the semiconductor switch, since the component diode is arranged in the reverse direction. Furthermore, an electric current flowing from the negative pole of the power semiconductor component to the positive pole of the power semiconductor component is conducted through the component diode, since the component diode is arranged in the forward direction. Furthermore, due to the antiserial arrangement of the first power semiconductor component and the second power semiconductor component, the first semiconductor switch and the second semiconductor switch are also arranged antiserially in the switch-off unit. Advantageously, the first semiconductor switch and the second semiconductor switch thus form a bidirectional semiconductor switch. Furthermore, the semiconductor switches can be used to quickly interrupt the charging current by means of a corresponding gate signal. In addition, due to the antiserial arrangement of the first power semiconductor component and the second power semiconductor component, the first component diode and the second component diode are also arranged antiserially in the switch-off arrangement.

In one embodiment, the first semiconductor switch and/or the second semiconductor switch is formed as a field-effect transistor, in particular as a metal-oxide-semiconductor field-effect transistor (MOSFET). In particular, the metal-oxide-semiconductor field-effect transistor has a silicon carbide material. If an n-channel field-effect transistor is used, a drain terminal of the field-effect transistor is assigned to the positive pole of the power semiconductor component and a source terminal of the field-effect transistor is assigned to the negative pole of the power semiconductor component. Alternatively, if a p-channel field-effect transistor is used, the source terminal of the field-effect transistor is assigned to the positive pole of the power semiconductor component and the drain terminal of the field-effect transistor is assigned to the negative pole of the power semiconductor component. Particularly preferably, the switch-off control device is configured to acquire the semiconductor forward voltage, in particular a gate-source voltage of the field-effect transistor, and to determine therefrom an amperage and/or a voltage as the at least one charging parameter.

In a further embodiment, the first semiconductor switch and/or the second semiconductor switch is formed as a bipolar transistor with an insulated gate electrode. If an n-channel bipolar transistor is used, a collector terminal of the bipolar transistor is assigned to the positive pole of the power semiconductor component and an emitter terminal of the bipolar transistor is assigned to the negative pole of the power semiconductor component. Alternatively, if a p-channel bipolar transistor is used, the emitter terminal of the bipolar transistor is assigned to the positive pole of the power semiconductor component and the collector terminal of the bipolar transistor is assigned to the negative pole of the power semiconductor component. Particularly preferably, the switch-off control device is configured to acquire the semiconductor forward voltage, in particular a base-emitter voltage of the bipolar transistor, and to determine therefrom an amperage and/or a voltage as the at least one charging parameter.

In one embodiment, the first semiconductor switch and/or the second semiconductor switch is an insulated-gate bipolar junction transistor (IGBT). In particular, it has a silicon material. In particular, this makes it possible to interrupt the charging current so quickly that a short-circuit current occurring in the event of a malfunction does not exceed a value of I=1 kA.

In one embodiment, a cathode of the component diode of the power semiconductor component is assigned to the positive pole of the power semiconductor component and an anode of the component diode of the power semiconductor component is assigned to the negative pole of the power semiconductor component.

In a particularly preferred embodiment, the first of the power semiconductor component and the second of the power semiconductor component are formed identically.

In one embodiment, it is provided that the switch-off control device is configured to switch off the first power semiconductor component and/or the second power semiconductor component by means of the control voltage.

In particular, the control voltage for switching off the first power semiconductor component and/or the second power semiconductor component is preferably at most 0 V. In particular, the first power semiconductor component is switched off and thus the charging current is interrupted if a control voltage of at most 0 V is present at the first power semiconductor component, in particular at a gate terminal of the first power semiconductor component. Furthermore, the second power semiconductor component is switched off and thus the charging current is interrupted if a control voltage of at most 0 V is present at the second power semiconductor component, in particular at a gate terminal of the second power semiconductor component. In particular, the first power semiconductor component and the second power semiconductor component are switched on and thus the charging current is not interrupted if a control voltage of 15 V to 20 V is applied to the first power semiconductor component and the second power semiconductor component, in particular to the respective gate terminals.

In one embodiment, the switch-off arrangement, in particular the first power semiconductor component and the second power semiconductor component, is electrically installed in series with an energy storage device connectable to the power supply device in a power circuit of the power supply device.

The invention is explained in more detail below with reference to the drawing. The Figures show:

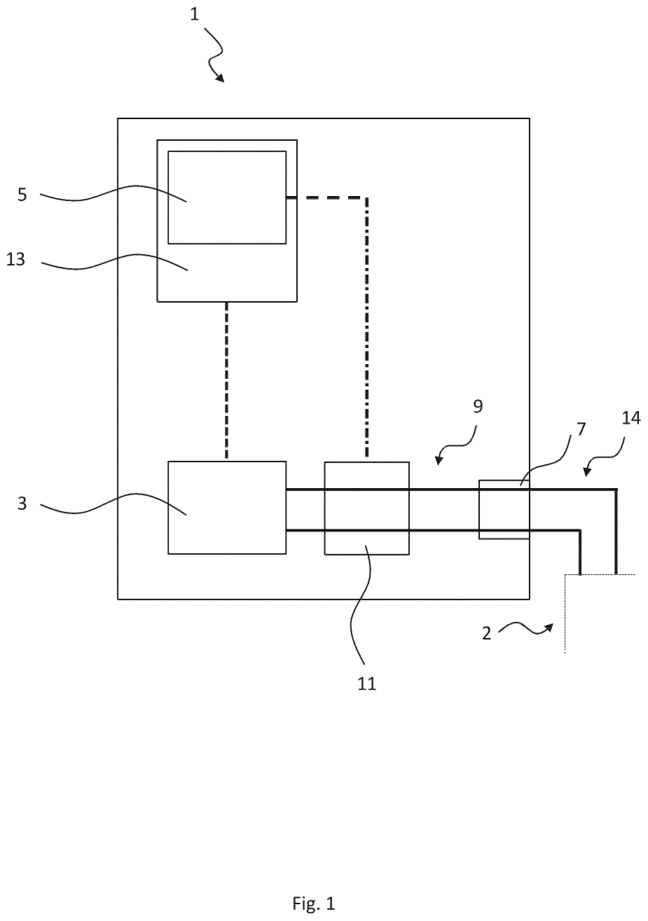

FIG. 1 shows a schematic representation of an embodiment example of a power supply device,

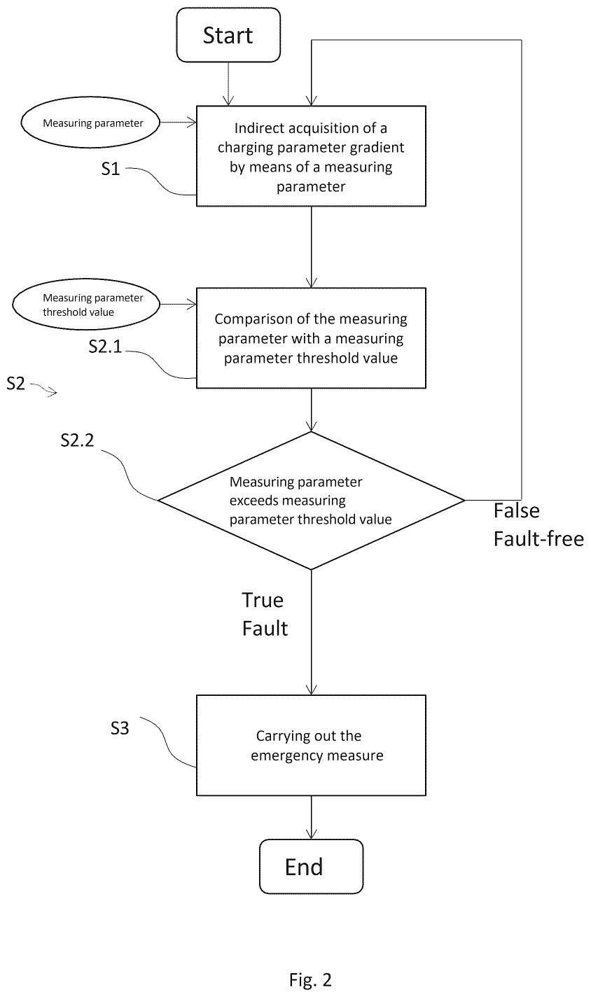

FIG. 2 shows a schematic representation of a process flow diagram of a method for operating the electrical power supply device 1 according to FIG. 1,

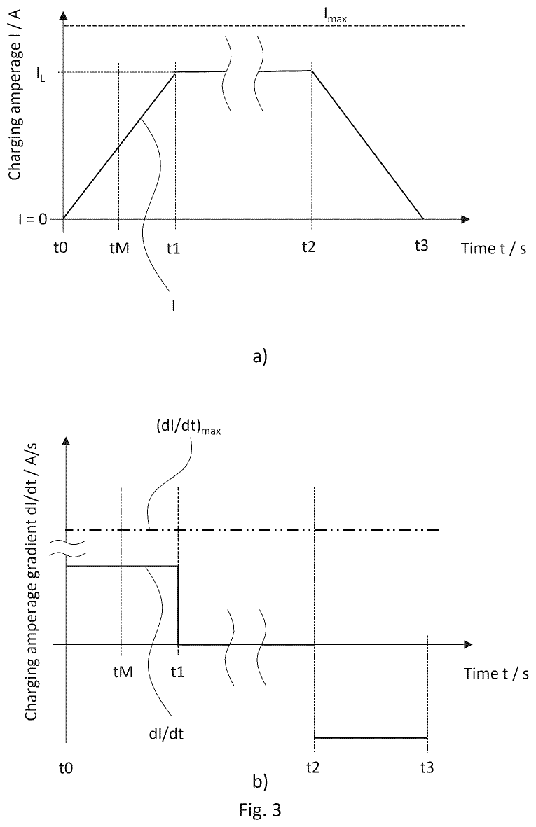

FIG. 3 shows a schematic representation of a charging amperage curve of a fault-free charging process,

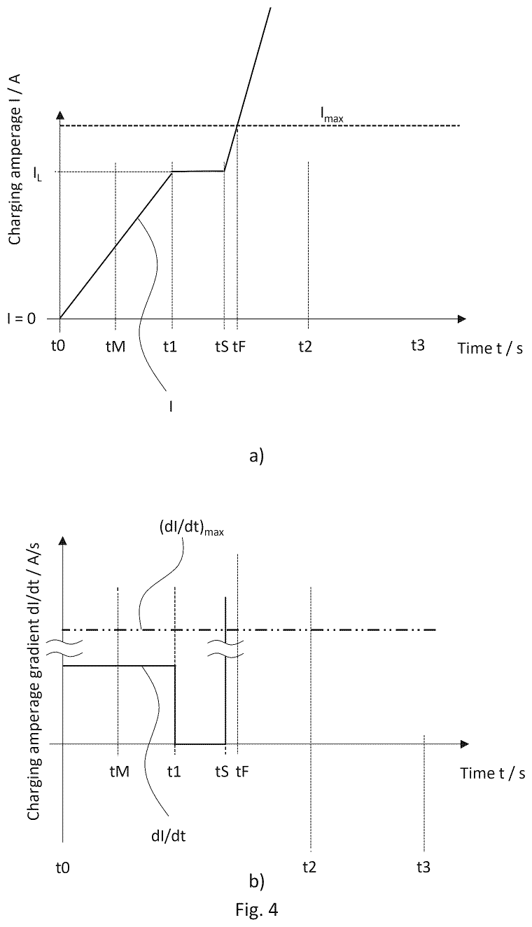

FIG. 4 shows a schematic representation of a charging amperage curve of a faulty charging process, wherein the fault is inferred by means of directly acquiring the charging parameter gradient and

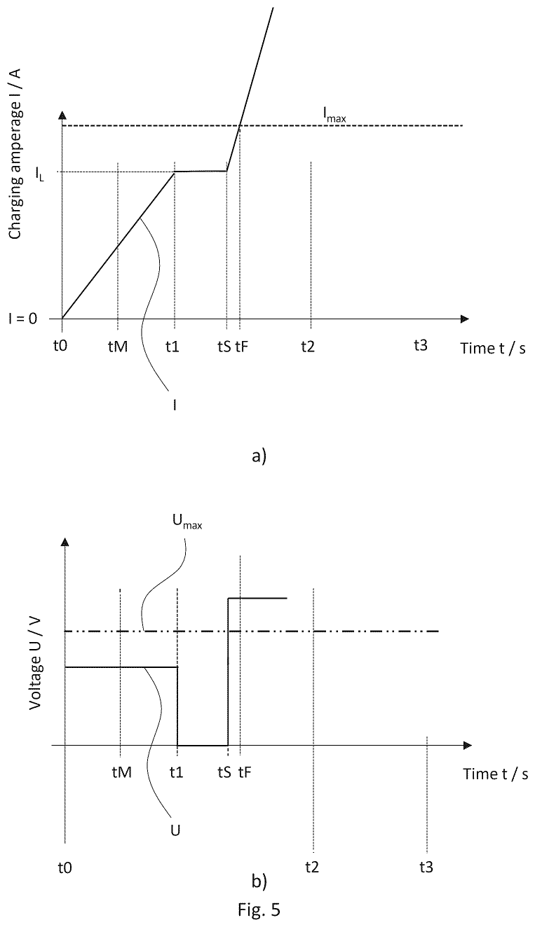

FIG. 5 shows a schematic representation of the charging amperage curve according to FIG. 4, wherein the fault is inferred by means of indirectly acquiring the charging parameter gradient.

FIG. 1 shows a schematic representation of an embodiment example of a power supply device 1 for unidirectional or bidirectional charging, in particular, an energy storage device 2, in particular a battery storage of an electric vehicle.

The power supply device 1 comprises power electronics 3, a switch-off control device 5 and an electrical interface 7. The power electronics 3 is configured to selectively close or open a power circuit 9 for charging the energy storage device 2. The electrical interface 7 is configured to be connected to the energy storage device 2 for charging the energy storage device 2. In the present case, the electrical interface 7 is connected to the energy storage device 2 by means of a charging cable 14.

The power supply device 1 also has a switch-off arrangement 11. The switch-off control device 5 is configured to be operatively connected to the power circuit 9 of the power supply device 1—mediated via the switch-off arrangement 11—and to interrupt the power circuit 9. For this purpose, the switch-off control device 5 is controllably operatively connected to the switch-off arrangement 11. The switch-off arrangement 11 is again configured to receive an interruption signal from the switch-off control device 5 and then interrupt the power circuit 9.

The switch-off control device 5 is integrated into a control device 13 of the power supply device 1. In an embodiment example not shown, the switch-off control device 5 is formed as a control device 13 of the power supply device 1. In yet another embodiment example not shown, the switch-off control device 5 is provided separately and in addition to the control device 13 of the power supply device 1 and is preferably operatively connected thereto.

The power supply device 1 and the switch-off control device 5 are in particular configured to carry out a method described in more detail below for operating the electrical power supply device 1.

FIG. 2 shows a schematic representation of a process flow diagram of a first embodiment example of a method for operating the electrical power supply device 1 according to FIG. 1 for unidirectional or bidirectional charging the energy storage device 2.

Identical and functionally identical elements are provided with the same reference numbers in all Figures, so that reference is made to the previous description in each case.

In the method, a temporal charging parameter gradient of a charging parameter which is characteristic of the charging process is acquired in a first step S1 during a charging process.

At least one charging current variable is used as the charging parameter, selected from a group consisting of the following: A charging power, a charging amperage, a charging voltage and a combination of at least two of the above charging current variables. Here, a charging current from the power supply device 1 to the energy storage device 2 and vice versa—which is known as bidirectional charging—can be monitored.

The charging parameter gradient can be acquired directly or indirectly: In a second embodiment example not shown in this Figure, the charging parameter gradient is acquired directly. If the charging parameter gradient is acquired directly, the charging parameter gradient is compared with a predetermined gradient threshold value. A fault of the charging process is inferred if the charging parameter gradient acquired exceeds the gradient threshold value.

As an alternative to direct acquisition, it is provided that the charging parameter gradient is acquired indirectly by measuring a measuring parameter which is characteristic of the charging parameter gradient. The measuring parameter is compared with a predetermined measuring parameter threshold value in a first second step S2.1 of a second step S2, wherein a fault of the charging process is inferred in a second second step S2.2 of the second step S2 if the measuring parameter exceeds the measuring parameter threshold value.

The measuring parameter used in this embodiment example is a voltage that drops due to an inductance, in particular of electronic components of the power supply device 1, in particular of a switch-off control device 5 of the power supply device 1, across a measuring segment through which the charging current or a partial current dependent on the charging current flows. The voltage u(t) dropping across the measuring segment having the inductance L is directly dependent on—in particular according to the equation u(t)=L·dI(t)/dt proportional to—the time gradient of the charging current or partial current I(t) and thus dependent on the charging parameter gradient. In one embodiment, the measuring parameter acquired is a voltage drop across a coil through which the charging current or partial current flows. Alternatively, the measuring segment has the inductance as a parasitic inductance. In this context, ‘parasitic’ means in particular that a line section or multiple undefined, not clearly delimited components and/or line sections of the charging device 1 and/or the energy storage device 2 are the cause of the inductance.

The charging parameter gradient and/or the measuring parameter is acquired at a line, the charging cable 14 connecting the power supply device 1 to the energy storage device 2, the power electronics 3, the electrical interface 7 and/or on the control device 13 of the power supply device 1.

At least one threshold value selected from the gradient threshold value and the measuring parameter threshold value is set in dependence on a limit charging parameter which is selected from a group consisting of: A permissible power gradient upper limit, a permissible power upper limit, a permissible amperage gradient upper limit, a permissible amperage upper limit, a permissible voltage gradient upper limit, a permissible voltage upper limit and a combination of at least two of the aforementioned limit values.

If the charging parameter gradient acquired indirectly via the measuring parameter in the second step S2 indicates a fault of the charging process, an emergency measure is carried out in a third step S3 to protect the power supply device 1 and/or the energy storage device 2 from damage. As an emergency measure, the power circuit 9 of the power electronics 3 is interrupted, in particular in such a way that the charging process is interrupted.

FIG. 3 shows a schematic representation of a charging amperage curve of a fault-free charging process.

During the charging process described here, a second embodiment example of a method for operating the electrical power supply device 1 according to FIG. 1 is carried out.

In this second embodiment example of the method—in contrast to the first embodiment example of the method in FIG. 2—the charging parameter gradient—in this case the charging amperage gradient—is acquired directly. If the charging parameter gradient is acquired directly, a fault of the charging process is inferred if the charging parameter gradient acquired exceeds a predetermined gradient threshold value.

The diagram a) shows a charging amperage curve of a fault-free charging process in which the power supply device 1 is charged by the energy storage device 2. Alternatively, the energy storage device 2—mediated via the power supply device 1—can also support or stabilize a power grid, for example.

In diagram a), a charging amperage I in amperes (A) is plotted against the time t in seconds(s). The charging process begins at a start time t0 and the charging amperage I—as a charging parameter—is increased starting at 0 A, in this example linearly, until a predetermined charging amperage I_{L} is reached at a first point in time t1. Between the points in time t0 and t1, the charging amperage gradient dI/dt is correspondingly constant and has a positive value (see diagram b)). It is also conceivable that the charging amperage I is increased non-linearly, for example progressively.

Diagram b) shows a first derivative of the charging amperage of diagram a), namely the charging amperage gradient dI/dt in A/s plotted against the time t in s. The charging amperage gradient represents the curve of the slope of the charging amperage over time. The gradient threshold value (dI/dt)ₘₐₓ is also shown. In a fault-free charging process, the charging amperage gradient dI/dt is smaller than the gradient threshold value (dI/dt)ₘₐₓ.

Diagram a) shows that between the first point in time t1 and a second point in time t2, the power supply device 1 is charged with the constant charging amperage I_{L}; the amperage gradient is thus zero (see diagram b)). From the second point in time t2, the charging amperage I is reduced, in this example linearly, until the charging process is completed at a third point in time t3. Between the points in time t2 and t3, the charging amperage gradient dI/dt is thus again constant and has a negative value (see diagram b)), however. It is also conceivable here that the charging amperage I is reduced non-linearly, for example regressively. The charging process between the points in time t1 and t2 usually takes significantly longer—multiple minutes to hours—than increasing and decreasing the charging amperage, which usually takes a few seconds to a minute.

The amperage upper limit Iₘₐₓ, which is above the constant charging amperage I_{L}, is also shown. In this case, the amperage upper limit Iₘₐₓ is an upper amperage limit of the energy storage device 2. If this is exceeded, the fuse of the energy storage device 2 is tripped. For example, an electric vehicle would then no longer be roadworthy.

At the measurement point in time tM considered here—as well as at all other points in time of this charging process—the charging amperage gradient dI/dt is smaller than the gradient threshold value (dI/dt)ₘₐₓ. As long as the charging amperage gradient dI/dt is smaller than the gradient threshold value (dI/dt)ₘₐₓ, no fault of the charging process is inferred, in particular, the charging process runs fault-free—provided there are no other faults. In a fault-free charging process, the charging amperage gradient dI/dt is preferably between 20 A/s and 100 A/s. The gradient threshold value (dI/dt)ₘₐₓ is preferably just above 1.0 A/μs, preferably the gradient threshold value (dI/dt)ₘₐₓ is 1.3 A/μs.

FIG. 4 shows a schematic representation of a charging amperage curve of a faulty charging process, wherein the fault is inferred by means of directly acquiring the charging parameter gradient. The charging amperage gradient dI/dt is acquired as the charging parameter gradient.

The diagrams a) and b) shown in FIG. 4 show the charging process of FIG. 3, wherein the second embodiment example of the method for operating the electrical power supply device 1 according to FIG. 1 is also carried out.

The two diagrams in FIG. 4 correspond to the two diagrams in FIG. 3, with the difference that the charging process does not proceed fault-free here. At a fault time tS, the power supply device 1 is short-circuited due to a fault. The charging amperage I then increases steeply. Measurements have shown that in the event of a short circuit, the charging amperage gradient dI/dt is greater than 1.5 A/μs and is thus significantly higher than the charging amperage gradient dI/dt in a fault-free charging process, which is preferably between 20 A/s and 100 A/s.

When using a power supply device 1 of the prior art, the fault would cause the charging amperage I to increase for so long and to such an extent that at a fault time tF the amperage upper limit Iₘₐₓ of the fuse of the energy storage device 2 is exceeded. If the energy storage device 2 is a battery of an electric vehicle, the electric vehicle would no longer be functional after the fault time tF.

This can be prevented by implementing the present method. Diagram b) shows that the charging amperage gradient dI/dt between the points in time t0 and t1—as in FIG. 3—is initially smaller than the gradient threshold value (dI/dt)ₘₐₓ. From the first point in time t1, the charging amperage gradient dI/dt is initially zero because the power supply device 1 is charged with a constant charging amperage I_{L}.

At the fault time tS, the charging amperage gradient dI/dt increases abruptly and almost vertically and usually exceeds the gradient threshold value (dI/dt)ₘₐₓ significantly within a few microseconds, which indicates a fault of the charging process. In this case, the emergency measure is carried out by interrupting the power circuit 9 of the power electronics 3 of the power supply device 1. The power circuit 9 of the power electronics 3 is interrupted so quickly that the fuse of the energy storage device 2 is not exposed to the fault of the charging process, in particular the fuse is not tripped. If the energy storage device 2 is a battery of an electric vehicle, the electric vehicle would continue to be functional.

FIG. 5 shows a schematic representation of the charging amperage curve according to FIG. 4, wherein the fault is inferred by means of indirectly acquiring the charging parameter gradient.

In contrast to the second embodiment example of the method carried out in FIGS. 3 and 4—in which the charging parameter gradient is acquired directly—the first embodiment example of the method mentioned in FIG. 2 is carried out in FIG. 5, in which the charging parameter gradient is acquired indirectly. The charging parameter gradient—i.e. the charging amperage gradient dI/dt—is acquired indirectly by measuring a measuring parameter which is characteristic of the charging parameter gradient. The measuring parameter is compared with a measuring parameter threshold value, wherein a fault of the charging process is inferred if the measuring parameter exceeds the measuring parameter threshold value.

The voltage U in volts (V) dropping due to an inductance is acquired here as the measuring parameter. A voltage upper limit Uₘₐₓ in volts (V) is used as the measuring parameter threshold value.

Diagram a) in FIG. 5 is identical to diagram a) in FIG. 4. Here too, a short circuit occurs in the power supply device 1 at the fault time tS and the charging amperage I increases steeply.

Diagram b) shows the temporal curve of the voltage drop U in volts (V) over the time t in s. It can be seen that the falling voltage U between the points in time t0 and t1 is initially lower than the measuring parameter threshold value Uₘₐₓ. From the point in time t1, the falling voltage U is initially zero because the power supply device 1 is charged with a constant charging amperage I and the induced voltage U is also zero with a charging amperage gradient dI/dt of zero.

At the fault time tS, the dropping voltage U increases abruptly and almost vertically and usually exceeds the measuring parameter threshold value Uₘₐₓ within a few microseconds, which indicates a fault of the charging process. In this case, as in FIG. 4, the emergency measure is carried out by interrupting the power circuit 9 of the power electronics 3 of the power supply device 1. The power circuit 9 of the power electronics 3 can also be interrupted so quickly in the case of indirect acquisition that the fuse of the energy storage device 2 is not exposed to the fault of the charging process, in particular the fuse is not tripped. If the energy storage device 2 is a battery of an electric vehicle, the electric vehicle would also continue to be functional.

1. A method for operating an electrical power supply device for unidirectional or bidirectional charging of an energy storage device, wherein
a temporal charging parameter gradient of a charging parameter which is characteristic of the charging process is acquired during a charging process, wherein
if a fault of the charging process is inferred on the basis of the charging parameter gradient, an emergency measure is carried out to protect the power supply device and/or the energy storage device from damage.

2. The method according to claim 1, wherein the charging parameter gradient
is acquired directly, wherein the charging parameter gradient is compared with a predetermined gradient threshold value, wherein a fault of the charging process is inferred if the charging parameter gradient acquired exceeds the predetermined gradient threshold value, or
is acquired indirectly by measuring a measurement parameter which is characteristic of the charging parameter gradient, and wherein the measurement parameter is compared with a predetermined measurement parameter threshold value, wherein a fault of the charging process is inferred if the measurement parameter exceeds the predetermined measurement parameter threshold value.

3. The method according to claim 1, wherein, as an emergency measure, a power circuit of power electronics, in particular of the power supply device or of the energy storage device, is interrupted.

4. The method according to claim 1, wherein at least one charging current variable is used as the charging parameter, which is selected from a group consisting of: A charging power, a charging amperage, a charging voltage and a combination of at least two of the above parameters, wherein a voltage dropping across a measuring segment due to an inductance is optionally acquired as a measuring parameter.

5. The method according to claim 1, wherein at least one threshold value, selected from the gradient threshold value and the measurement parameter threshold value, is set in dependence on a limit charging parameter which is selected from a group consisting of: A permissible power gradient upper limit, a permissible power upper limit, a permissible amperage gradient upper limit, a permissible amperage upper limit, a permissible voltage gradient upper limit, a permissible voltage upper limit and a combination of at least two of the aforementioned limit values.

6. The method according to claim 1, wherein
the charging parameter gradient and/or the measuring parameter is acquired on a line, a charging cable connecting the power supply device to the energy storage device, power electronics, an electrical interface and/or on a control device of the power supply device.

7. A switch-off control device for a power supply device for unidirectional or bidirectional charging of an energy storage device, wherein the switch-off control device is configured to perform a method according to claim 1.

8. The switch-off control device according to claim 7, wherein
the switch-off control device is configured to be operatively connected to a power circuit of the power supply device and to interrupt the power circuit.

9. The switch-off control device according to claim 7, wherein
the switch-off control device is formed by a control device of the power supply device.

10. A power supply device for unidirectional or bidirectional charging of an energy storage device, comprising:
power electronics which is configured to selectively close or open a power circuit for charging the energy storage device;
a switch-off control device according to claim 7, and
an electrical interface, configured to be connected to the energy storage device for charging the energy storage device.

11. The power supply device according to claim 10, wherein
the switch-off control device is integrated into a control device of the power supply device or is formed as a control device of the power supply device.
